(19) United States
(12) Patent Application Publication
(10) Pub. No.: US 2008/0046424 A1
(43) Pub. Date: Feb. 21, 2008

(54) System and method of selecting images according to color content

(76) Inventor: Richard B. Horton, Frisco, TX (US)

Correspondence Address: DOCKET CLERK, P.O. DRAWER 800889, DALLAS, TX, 75380, US

(21) Appl. No.: 11/821,374

(22) Filed: Jun. 22, 2007

Related U.S. Application Data
(60) Provisional application No. 60/816,087, filed on Jun. 23, 2006.
(60) Provisional application No. 60/835,787, filed on Aug. 4, 2006.

(51) Int. Cl. G06F 17/30

(52) U.S. Cl. 707/6

(57) ABSTRACT

A method and apparatus are provided that include a database of images, a user interface device, and a search device. The search device receives a search color, calculates a similarity measure for a plurality of images in the database, selects an image having a similarity measure indicating a greatest similarity between the search color and the color content of the image, and sends the selected image to the user interface device. The search color and the color content of the images in the database are represented in a first color model. The similarity measure is based upon a comparison of the search color and the color content of the image.

### CROSS-REFERENCE TO RELATED APPLICATIONS

This application claims priority to Provisional U.S. Patent Application Ser. No. 60/816,087, filed Jun. 23, 2006, and entitled “METHOD OF SELECTING PRODUCTS ACCORDING TO CHOSEN COLOR” and Provisional U.S. Patent Application Ser. No. 60/835,787, filed Aug. 4, 2006, and entitled “METHOD OF SELECTING PRODUCTS ACCORDING TO CHOSEN COLOR.” The above Provisional U.S. patent applications are incorporated herein by reference for all purposes as if fully set forth herein.

### TECHNICAL FIELD

The present invention is directed, in general, to a system and method of selecting images and, more specifically, to selecting images from a database according to color content.

### BACKGROUND

Persons selecting a product typically rely on manual processes when selecting a product. For example, interior decorators may make mental comparisons to match pictures to interiors. Similarly, persons selecting a clothing accessory may view a product and bring to mind other articles of clothing that they own in order to assess how well the product would accompany the article of clothing.

Physical displays such as picture shops, furniture stores, and art galleries typically do not allow decorators to easily find pictures and other interior design items that match a specific interior. Catalogs and books may provide more flexibility in product selection, whether pictures, interior design items or clothing and accessories, but typically also are manually intensive and imprecise.

While some websites may provide the ability to peruse products by style and subject, these searches are generally text based and typically do not allow the user to search by color.

There is, therefore, a need in the art for a system, process and device for selecting products according to color.

### SUMMARY

In one embodiment of the present invention, a method of selecting an image in a database of images based upon color includes receiving a search color, calculating a similarity measure for a plurality of images in the database, and selecting an image having a similarity measure indicating a greatest similarity between the search color and the color content of the image. The search color and the color content of the images in the database are represented in a first color model. The similarity measure is based upon a comparison of the search color and the color content of the image.

In another embodiment of the present invention, an apparatus includes an image database including a plurality of images and a search device. The search device is operable to receive a search color, calculate a similarity measure for a plurality of images in the database, select an image having a similarity measure indicating a greatest similarity between the search color and the color content of the image, and transmit the selected image. The search color and the color content of the images in the database are represented in a first color model. The similarity measure is based upon a comparison of the search color and the color content of the image.

In further embodiments of the invention, the apparatus includes a user interface device. The search device receives the search color from the user input device and transmits the selected image to the user input device.

In still other embodiments of the present invention, a method for selecting an object from a database of a plurality of objects includes receiving a search color represented in a color model. The database includes, for a plurality of objects, an image of the object and associated information relating to the object. The color content of the images is represented in the color model. The method further includes calculating a similarity measure for a plurality of images in the database. The similarity measure is based upon a comparison of the search color and the color content of the image. The method also includes selecting an image having a similarity measure within a predetermined range of similarity measure values. The method further includes displaying the selected image and the associated information relating to the object.

The foregoing has outlined rather broadly the features and technical advantages of the present invention so that those skilled in the art may better understand the detailed description of the invention that follows. Additional features and advantages of the invention will be described hereinafter that form the subject of the claims of the invention. Those skilled in the art will appreciate that they may readily use the conception and the specific embodiment disclosed as a basis for modifying or designing other structures for carrying out the same purposes of the present invention. Those skilled in the art will also realize that such equivalent constructions do not depart from the spirit and scope of the invention in its broadest form.

### BRIEF DESCRIPTION OF THE DRAWINGS

For a more complete understanding of the present invention, and the advantages thereof, reference is now made to the following descriptions taken in conjunction with the accompanying drawings, wherein like numbers designate like objects, and in which:

FIG. 1 depicts a block diagram of a system for selecting images from a database according to color content in accordance with the present invention;

FIG. 2A presents a schematic diagram of the contents of a database of images in accordance with the present invention;

FIG. 2B shows a schematic diagram of an image record in the database of FIG. 2A; and

FIG. 3 depicts a flowchart of a process in accordance with the present invention.

### DETAILED DESCRIPTION

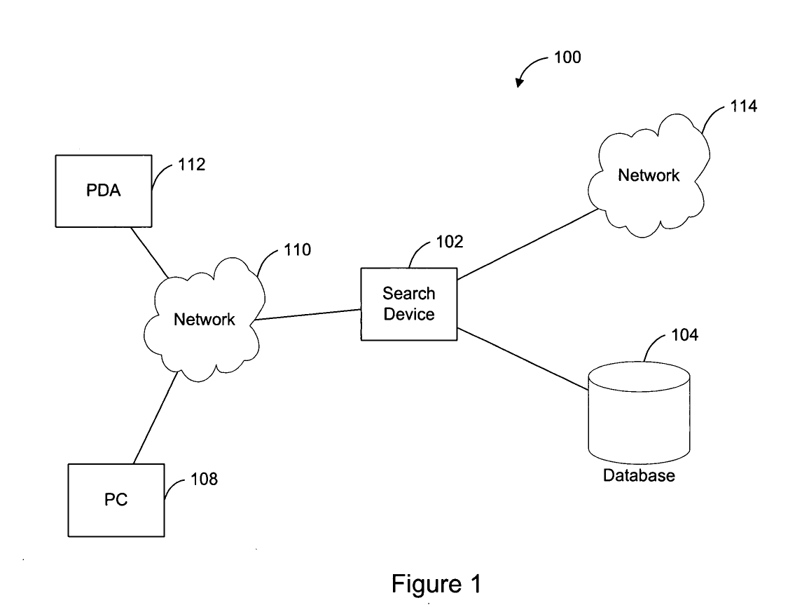

FIGS. 1 through 3, discussed below, and the various embodiments used to describe the principles of the present invention in this patent document are by way of illustration only and should not be construed in any way to limit the scope of the invention. Those skilled in the art will understand that the principles of the present invention may be implemented in any suitably arranged device. The numerous innovative teachings of the present application will be described with particular reference to the presently preferred embodiment.

FIG. 1 depicts a block diagram of a system 100 for selecting images from a database according to color content in accordance with the present invention. The system includes a search device 102 and a database 104. The database includes images. In one embodiment of the invention, the images depict objects that a user of the system 100 may select among. In another embodiment, the stored images are themselves the objects the user is selecting. Where the images represent other objects, the objects may include paintings, photographs, drawings. The objects may include articles of clothing, such as handbags, shoes, belts, dresses, trousers or shirts. The objects may include kitchen utensils or decorative objects.

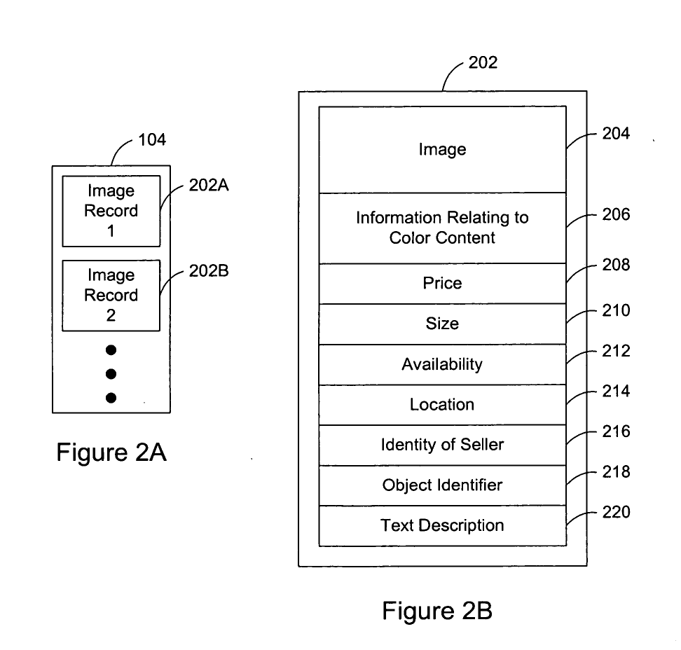

FIG. 2A presents a schematic diagram of the contents of the database 104. For each image in the database 104, a record 202 containing the image is stored in the database. In the database depicted in FIG. 2A, Image 1 is stored in (or associated with) image record 202A and Image 2 is stored in (or associated with) image record 202B.

FIG. 2B shows a schematic diagram of an example image record 202 in the database 104. The image record 202 includes the image 204. The stored image 204 includes data representing the color content of the image 204 (for example the color of each pixel in a digitized image). Such data may enable the image to be displayed on a display device. The image record 202 may also include information 206 relating to the color content of the image. The information 206 may be in the form of a histogram of some or all of the colors in the image 204, a collection of samples of the colors from equally spaced pixels in the image 204, or other reduced-size representation of the color content of the image 204, in order to permit faster searching of the image records 202 in the database 104.

The image record 202 may also contain additional information relating to the image 204 or to an object or objects depicted in or associated with the image 204. Such additional information may include price 208, size 210, availability 212, location 214 and seller 216. The additional information may include a text description 220 of the image 204 or of the object or objects depicted in or associated with the image 204. The text description 220 may describe a style of the object—for example, ‘impressionist’ for a painting, ‘retro’ for a coffee maker, or ‘biker’ for a belt. The text description may describe the content of the image—for example, ‘cattle’ in a painting or a ‘teddy bear’ on a shirt.

A user of the search device 102 may use a personal computer (PC) 108 to submit one or more search colors to the search device 102. The search device 102 then generates a similarity measure for one or more image records 202 in the database 104. The similarity measure represents how closely the color content of the image 204 “matches” the search color(s) according to one or more predetermined matching criteria. The search device 102 may generate the similarity measure based upon either or both of the information 206 relating to the color content of the image 204 and the color content of the image 204 itself. The search device 102 may rank the images 204 according to their similarity measure and select one or more images 204 that have the greatest similarity to the search color(s), to send to the PC 108 for display to the user.

In other embodiments of the invention, the user may select one or more of the types of additional information 208-216 stored in the database 104 and submit a target value or range of values for each selected type of additional information 208-216, along with the search color(s). In such embodiments, the similarity measure compares the target values with the additional information 208-216, as well as comparing the search color(s) with the color content of the images 204, in order to produce an aggregate measure of similarity.

Similarly, where the image record 202 includes a text description 220, the user may submit a text string to search for in the text description 220. The search engine 102 may search first for image records 202 including the submitted text string and then generate a similarity measure for only the image records 202 including the submitted text string.

Where the search device 102 selects a plurality of images 204 to send to the user, the search device 102 may also send an indication of the relative ranking of the selected images. Further, the search device 102 may send along with each image 204 information relating to the similarity measure calculated for its image record 202, in order to indicate to the user whether the best match is actually a good match, or just the best of a group of poor matches.

In other embodiments of the invention, the image record 202 also includes an object identifier 218 that identifies an object or objects depicted in or associated with the image 204. Once the search device has selected one or more image records 202 that most closely match the search color and/or additional search parameters, the search device 102 may use the object identifier 218 to obtain further information via a network 114 about the image 204 or to an object or objects depicted in or associated with the image 204. The search engine may then send the further information along with the image 204 to the user for display.

The network 114 may be a proprietary network or the Internet. The search device 102 may also use information 216 about a seller of the image or an object associated with the image, along with the object identifier 218, in obtaining further information via network 114.

The search device 102 may select a plurality of image records 202 from the database 104 based upon a search criteria. Where the user or a system designer has specified a number of images that the search device 102 should find in a search, the situation may arise that fewer than that number of image records 202 match the search criteria. In response, the search device 102 may alter the search criteria in order to produce more matching search records and re-run the search. If the second run results in more than the specified number of matching image records 202, the search device 102 may rank the matching records 202 and present the specified number of records 202 that have the greatest similarity to the search criteria.

Color is typically represented in a color model. Example color models include red-green-blue (RGB), cyan-magenta-yellow-black (CMYK), hue-saturation-value (HSV), and the Pantone color system. Images for display on a computer monitor may be stored in the RGB color model. Printed colors are often specified using the CMYK color model. Colors for clothing and accessories are often specified using the Pantone color system. It will be understood that other color systems may be utilized.

In some embodiments of the invention, the images 204 in the database 104 are stored in a first color model, while the search color specified by a user is expressed in a second color model. In such a situation, one or both of the PC 108 or the search device 102 are capable of converting the search color from the second color model to the first color model before searching for the closest matching image(s) 204 in the database 104.

In other embodiments, a user of the search device 102 may use a personal digital assistant (PDA) 112 to submit one or more search colors to the search device 102 and to view images found by the search device 102. The PC 108 and PDA 112 are coupled to the search device 102 by a network 110. In some embodiments, the network 110 may be a wireless communications network (such as a cellular network) or the Internet. In such embodiments, the search device 102 and the database 104 may be implemented as a Web server. In other embodiments, the PC 108 and the PDA 112 may be coupled directly to the search device 102.

In some embodiments of the invention, the user of the system 100 selects one or more search colors by displaying a picture and using a cursor or stylus to indicate a portion of the picture. The portion may be a single pixel, in which case the color of the pixel is used as a search color. The portion may be a collection of pixels, in which case a dominant color in the collection may be used as the search color. In other embodiments, a color that represents a balance of all the pixel colors in the indicated region may be used as the search color. The user may repeat this action to select one or more additional search colors.

The term picture is used here merely to avoid confusion between a picture used in selecting a search color and images stored in the data base 104. As used herein, both pictures and images are stored visual representations that may be displayed to a user. Furthermore, an image from the database may be used as a picture from which a search color is selected.

In some embodiments of the invention, the picture is stored in, and the functionality of selecting search colors is provided by, the PC 108 or the PDA 112. In other embodiments, the search device 102 stores the picture, or receives the picture via the network 114 or the network 110. In such embodiments, the search device 102 then sends the picture to the PC 108 or the PDA 112 for display to the user, receives from the user an indication of the indicated portion of the picture, and determines the search color thus selected by the user.

Where the PC 108 or the PDA 112 is equipped with a camera, the camera may be used to acquire a picture of a scene or object for which the user desires to select a matching image from the database 104. After acquiring the picture, the user may then use it to select one or more search colors, as described above.

Certain lighting conditions, certain characteristics of a camera, or other circumstances may result in a picture that does not faithfully reproduce the colors of the scene that was photographed. In such a situation the PC 108, the PDA 112, or the search device 102 may correct the colors in the picture (or the selected color from the picture) in order to compensate for the lighting conditions, the characteristics of the camera, or the other circumstances.

In other embodiments of the invention, a color wheel or other figure(s) is displayed to the user for the selection of one or more search colors. A single such figure may include all possible search colors or a collection of such figures may be presented, each including a subset of the possible search colors. The user may use a cursor or stylus to indicate the one or more desired search colors on the color wheel or figure(s).

In still other embodiments, the user enters the search color(s) numerically. In yet other embodiments, the user enters the search color(s) textually—for example, by name.

An example of a matching criteria for use by the search device 102 is now described, where the color content of the search color and each image 204 are represented in the RGB color model. For a pixel in the image 204 (or a sample in the information 206 relating to the color content of the image 204), the search device 102 calculates the difference between the search color and the pixel/sample for each of the red, green and blue components, calculates the absolute values of the three differences and sums the absolute values to produce an aggregate difference measure between the search color and the pixel/sample. The search engine then determines whether this aggregate difference measure is less than a predetermined threshold value and, if it is, categorizes the pixel/sample as a ‘match’ for the search color. While repeating this process for each pixel in the image 204 (or sample in the information 206 relating to the color content of the image 204), the search device 102 maintains a running tally of the number of matching pixels or samples.

After tallying the number of matching pixels in a plurality of image records 202, the search device 102 ranks the images 204 in decreasing order of number of matching pixels. The first entries in the resulting list are the images 204 with the greatest similarity to the search color. As described above, where fewer than a specified number of matching images are found using a first threshold value, the search may be repeated using a second, larger threshold value, in an attempt to increase the number of matching images 204 found in the search.

Where a plurality of search colors are submitted by a user, each pixel may be checked against all search colors, to determine whether the pixel matches any of the search colors. An aggregate running tally of pixels matching any search color may be maintained. In other embodiments of the invention, separate running tallies for each search color may be maintained and a weighting applied to the search colors, such that images 204 having more pixels matching one of the search colors will rank higher than images 204 having more pixels matching another of the search colors.

It will be understood that other matching and ranking criteria may be used without departing from the scope of the present invention. A balanced match may be performed, in which a specified number of pixels must match each of a plurality of search colors before an image 204 is characterized as matching the search colors. Pixels may be compared against colors that are complementary to a search color specified by the user. Statistical measures such as least squared regression may be used to characterize the degree to which an image 204 matches one or more search colors.

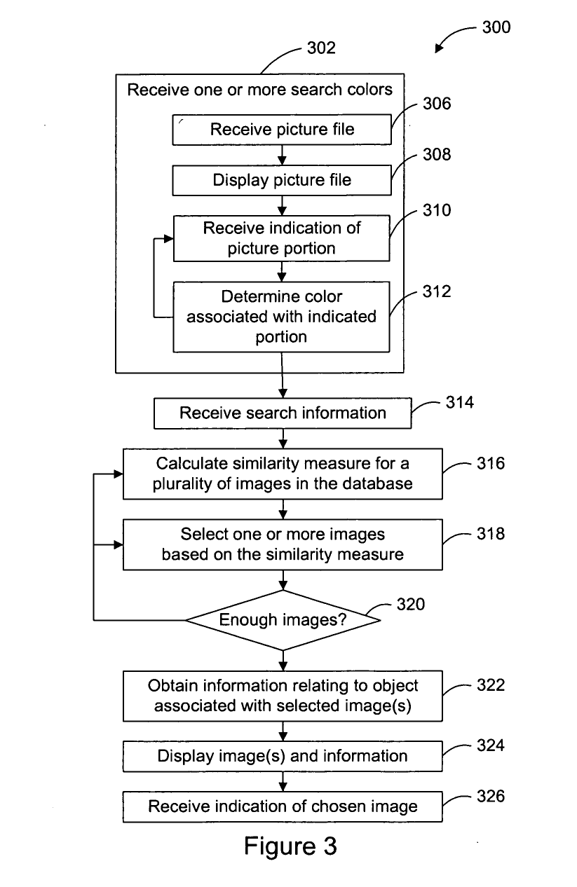

FIG. 3 depicts a flowchart of a process 300 in accordance with the present invention. Steps of the process 300 will be described with reference to the system 100 of FIG. 1, the database 104 of FIG. 2A and the image record 202 of FIG. 2B.

The process 300 begins with step 302, wherein one or more search colors are received. A user of the system 100 may specify the search color(s) using functionality present in the PC 108 or the PDA 112 and cause the search color(s) to be sent to the search device 102.

In other embodiments of the invention, the search device 102 performs steps 306-312. In step 306, the search device receives a picture file and displays the picture file to the user in step 308. In step 310, the search device receives from the user an indication of a portion of the picture and, in step 312, determines a color associated with the indicated portion of the picture. The user may repeat steps 310 and 312 until a desired number of search colors have been specified.

In optional step 314, the search device 102 receives additional search information, corresponding to target values or ranges for the additional information 208-216 and 220 that may be stored in the image records 202 stored in the database 104. In step 316, the search engine 102 calculates a similarity measure for a plurality of the image records 202 in the database 104 using the search color(s) received in step 302. The search device 102 may also use any additional search information received in step 314 in the calculation of similarity measures in step 316.

In step 318, the search device 102 selects one or more image records 202 based upon the similarity measures calculated in step 316. The search device 102 may check in step 320 whether a predetermined minimum number of matching images were selected in step 318. If not, the search device returns either to step 316 to recalculate similarity measures using a different similarity calculation or to step 318 to select image records 202 using a different threshold for the similarity measures originally calculated in step 316.

Where an object identifier 218 is stored in the image records 202, information relating to objects associated with the image records 202 selected in step 318 may be obtained in step 322. In step 324, the selected images 204 are displayed to the user. Additional information about the images 204 and objects associated with the images 204 may also be displayed to the user in step 324. Where a plurality of selected images 204 are displayed to the user in step 324, an indication may be received in step 326 of which of the selected images 204 the user has chosen—for example, for purchase.

Those skilled in the art will recognize that, for simplicity and clarity, the full structure and operation of all devices and processes suitable for use with the present invention is not being depicted or described herein. Instead, only so much of a system and method of selecting images according to color content as is unique to the present invention or necessary for an understanding of the present invention is depicted and described. The remainder of the construction and operation of such a system and method as is described herein may conform to any of the various current implementations and practices known in the art.

Those of skill in the art will also recognize that not all steps in the above-described processes must be performed in the order described. Further, not all steps of any process, particularly the optional steps, must necessarily be performed in conjunction with all other steps, and can be omitted from the process or performed independent of other steps of the process.

It is important to note that while the present invention has been described in the context of a fully functional system, those skilled in the art will appreciate that at least portions of the mechanism of the present invention are capable of being distributed in the form of an instruction set contained within a machine usable medium in any of a variety of forms, and that the present invention applies equally regardless of the particular type of instruction or signal bearing medium utilized to actually carry out the distribution. Examples of machine usable mediums include: nonvolatile, hard-coded type mediums such as read only memories (ROMs) or erasable, electrically programmable read only memories (EEPROMs), user-recordable type mediums such as floppy disks, hard disk drives and compact disk read only memories (CD-ROMs) or digital versatile disks (DVDs), and transmission type mediums such as digital and analog communication links.

Although an exemplary embodiment of the present invention has been described in detail, those skilled in the art will understand that various changes, substitutions, variations, and improvements of the invention disclosed herein may be made without departing from the spirit and scope of the invention in its broadest form.

None of the description in the present application should be read as implying that any particular element, step, or function is an essential element which must be included in the claim scope: THE SCOPE OF PATENTED SUBJECT MATTER IS DEFINED ONLY BY THE ALLOWED CLAIMS. Moreover, none of these claims are intended to invoke paragraph six of 35 USC §112 unless the exact words “means for” are followed by a participle.

It may be advantageous to set forth definitions of certain words or phrases used throughout this patent document: the terms “include” and “comprise,” as well as derivatives thereof, mean inclusion without limitation; the term “or” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and if the term “controller” is utilized herein, it means any device, system or part thereof that controls at least one operation, whether such a device is implemented in hardware, firmware, software or some combination of at least two of the same. It should be noted that the functionality associated with any particular controller may be centralized or distributed, whether locally or remotely.

What is claimed is:

1. A method of selecting an image in a database of images based upon color, the method comprising:
receiving a search color represented in a first color model;
calculating a similarity measure for a first plurality of images in the database, wherein color content of the images in the database is represented in the first color model and the similarity measure is based upon a comparison of the search color and the color content of the image;
selecting an image having a similarity measure indicating a greatest similarity between the search color and the color content of the image.

2. The method of claim 1, wherein:
the database further comprises, for each image, information relating to the color content of the image, wherein the information is represented in the first color model; and
calculating a similarity measure for an image further comprises calculating a similarity measure based upon a comparison of the search color and the information relating to the color content of the image.

3. The method of claim 1, wherein receiving a search color further comprises:
receiving a picture;
displaying the picture to a user;
receiving from the user an indication of a portion of the picture; and
determining a color associated with the indicated portion of the picture.

4. The method of claim 3, wherein colors in the picture are represented in a second predefined color model and receiving a search color further comprises converting the color associated with the indicated portion of the picture from the second color model to the first color model.

5. The method of claim 1, wherein receiving a search color further comprises receiving a plurality of search colors and calculating a similarity measure for an image further comprises calculating the similarity measure based upon a comparison of the plurality of search colors and the color content of the image.

6. The method of claim 1, wherein selecting the image further comprises selecting a second plurality of images having similarity measures within a first predetermined range of similarity measure values.

7. The method of claim 6, wherein selecting the image further comprises:
if the number of images in the second plurality of images is below a predetermined value, selecting a third plurality of images having similarity measures within a second predetermined range of similarity measure values.

8. The method of claim 1, wherein:
the database further comprises, for each image in the database, information relating to an object associated with the image; and
the method further comprises presenting the selected image and the information relating to the object associated with the image.

9. The method of claim 1, wherein:
the database further comprises, for each image in the database, information relating to an object associated with the image;
receiving a search color further comprises receiving search information;
calculating a similarity measure further comprises calculating a combined similarity measure, wherein the combined similarity measure is based upon a comparison of the search color and the color content of the image and a comparison of the search information and the information relating to the object associated with the image; and
selecting an image further comprises selecting a second plurality of images having combined similarity measures within a predetermined range of combined similarity measure values.

10. An apparatus, comprising:
an image database, comprising a plurality of images, wherein color content of the images in the database is represented in a first color model; and
a search device, operable to:
receive a search color represented in the first color model,
calculate a similarity measure for a first plurality of images in the database, wherein the similarity measure is based upon a comparison of the search color and the color content of the image,
select an image having a similarity measure indicating a greatest similarity between the search color and the color content of the image, and
transmit the selected image.

11. The apparatus of claim 10, further comprising
a user interface device operable to receive information from a user of the system and present information to the user, wherein the search device receives the search color from the user interface device and transmits the selected image to the user interface device

12. The apparatus of claim 11, wherein the user interface device is further operable to:
receive a picture file;
display the picture file to the user;
receive an indication of a portion of the picture file from the user;
determine a color associated with the indicated portion of the picture file; and
send the determined color to the search device as the search color.

13. The apparatus of claim 10, wherein:
the image database further comprises, for each image, information relating to the color content of the image, wherein the information is represented in the first color model; and
the search device is further operable to calculate a similarity measure by calculating a similarity measure based upon a comparison of the search color and the information relating to the color content of the image.

14. The apparatus of claim 10, wherein the search device is further operable to receive a search color by:
receiving a picture file;
receiving from the user an indication of a portion of the picture file; and
determining a color associated with the indicated portion of the picture file.

15. The apparatus of claim 10, wherein the search device is further operable to:
receive a search color by receiving a plurality of search colors; and
calculate a similarity measure for an image by calculating a similarity measure based upon a comparison of the plurality of search colors and the color content of the image.

16. The apparatus of claim 10, wherein the search device is further operable to:
select an image by selecting a second plurality of images having similarity measures within a first predetermined range of similarity measure values; and
transmit the selected image by transmitting the second plurality of images via the communication interface.

17. The apparatus of claim 16, wherein the search device is further operable to:
select an image by selecting a third plurality of images having similarity measures within a second predetermined range of similarity measure values if the number of images in the second plurality of images is below a predetermined value; and
transmit the selected image by transmitting the third plurality of images via the communication interface.

18. The apparatus of claim 10, wherein the database further comprises, for each image in the database, an identifier of an object associated with the image, and the search device is further operable to:
obtain information relating to the object associated with the selected image using the identifier of the object associated with the selected image; and
transmit the selected image by transmitting the selected image and the information via the communication interface.

19. The apparatus of claim 10, wherein the database further comprises, for each image in the database, information relating to an object associated with the image and the search device is operable to:
receive a search color by receiving a search color and search information;
calculate a similarity measure by calculating a combined similarity measure for each image in the database, wherein the combined similarity measure is based upon a comparison of the search color and the color content of the image and a comparison of the search information and the information relating to the object associated with the image;
select an image by selecting a plurality of images having combined similarity measures within a predetermined range of combined similarity measure values; and
transmit the selected image by transmitting the plurality of images via the communication interface.

20. A method of selecting an object, the method for use with a database of objects, the database comprising, for a plurality of objects in the database, an image of the object and associated information relating to the object, wherein color content of the images is represented in a color model, the method comprising:
receiving a search color represented in the color model;
calculating a similarity measure for a plurality of images in the database, wherein the similarity measure is based upon a comparison of the search color and the color content of the image;
selecting an image having a similarity measure within a predetermined range of similarity measure values;
displaying the selected image and the associated information relating to the object.
